(19) United States
(12) Patent Application Publication
(10) Pub. No.: US 2026/0225395 A1
(43) Pub. Date: Aug. 6, 2026

(54) BEADING PATTERN HOLDING STAND AND METHODS FOR USING THE SAME

(71) Applicant: Christina Athanasuleas, Killen, AL (US)

(72) Inventor: Christina Athanasuleas, Killen, AL (US)

(21) Appl. No.: 19/464,853

(22) Filed: Jan. 30, 2026

Related U.S. Application Data
(60) Provisional application No. 63/752,396, filed on Jan. 31, 2025.

(51) Int. Cl. B44B 3/06

(52) U.S. Cl. CPC B44B 3/065

(57) ABSTRACT

A stand includes a body and a glider bar. The body has a front surface, a back surface, a bottom edge, a top edge, and lateral side edges. The body includes two side segments and a central segment. Each side segment includes a magnetic material. The central segment defines a pocket to receive a bead map. The glider bar has a first end portion, a second end portion, and a central portion. The first end portion secures to one side segment and the second end portion secures to the other side segment. The central portion has a first major edge and a second major edge. The first major edge has a pattern configured to match a single row of a desired bead stitch. The first major edge is extends across the central segment such that the single row of the desired bead stitch is viewable along the first major edge.

### CROSS-REFERENCE TO RELATED APPLICATION

This application claims priority to U.S. Provisional Application No. 63/752,396, filed Jan. 31, 2026, the entire contents of which are hereby incorporated by reference.

### BACKGROUND

### 1. Technical Field

The present disclosure relates to beading and, more specifically, to a stand for holding a beading pattern and a methods for using same.

### 2. Discussion of Related Art

Beading patterns can be complex and keeping track of one's place while beading can be difficult. For example, a beading pattern has a number of columns and rows with different color beads forming the pattern. While following a pattern, the gaze of a beader must shift between the pattern, the workpiece, and a beading needle to guide the needle through the beads of the pattern. In addition, depending on the stitch, the beads for a given pattern may not be immediately next to one another on the pattern. For at least these reasons, while beading, a beader may lose their place or make mistakes in a beading pattern while shifting between the pattern and the beading needle.

Thus, there is a need for a device to hold a beading pattern and allow a beader to keep their place during a beading process.

### SUMMARY

This disclosure relates generally to devices to hold a beading pattern and allow a beader to keep their place during a beading process and methods of using the same.

In an aspect of the present disclosure, a stand includes a body and a glider bar. The body has a front surface, a back surface, a bottom edge, a top edge, and lateral side edges. The back surface is opposite the front surface. The bottom edge, the top edge, and the lateral side edges are disposed at the extremities of the front surface and the back surface and extend between the front surface and the back surface. The bottom edge is opposite the top edge and is configured to support the body on a surface during use. The lateral side edges are opposite one another and extend between the top edge and the bottom edge. The body includes two side segments and a central segment. The two side segments extend a length of each lateral side edge between the top edge and the bottom edge. Each side segment extends from the respective lateral side edge towards the opposite lateral side edge such that each side segment form a side area of the front surface. Each side segment includes a magnetic material substantially covering the respective side area. The central segment is disposed between two side areas. The central segment defines a pocket configured to receive a bead map therein. The central segment includes substantially transparent cover configured to allow the bead map to be viewed therethrough. The glider bar has a first end portion, a second end portion, and a central portion. The first end portion selectively magnetically secures to a first side segment of the two side segments and the second end portion selectively magnetically secured to a first side segment of the two side segments. The central portion is disposed between the first end portion and the second end portion. The central portion has a first major edge extending between the first end portion and the second end portion and a second major edge extending between the first end portion and the second end portion opposite the first major edge. The first major edge has a first pattern configured to match a single row of a first desired bead stitch. The first major edge is configured to extend across the central segment such that the single row of the first desired bead stitch of the bead map is viewable along the first major edge.

In aspects, the central segment includes a slot defined along the top edge configured to allow the bead map to be slid into and out of the pocket. The first pattern may be configured to match a loom stitch, a Delica-brick stitch, a Delica-peyote stitch, a peyote stitch, or a brick stitch. The second major edge may have a second pattern configured to match a single row of a second desired bead stitch. The second pattern may be different from the first pattern. The second major edge may be configured to extend across the central segment such that a single row of the second desired bead stitch of the bead map is viewable along the second major edge. The glider bar may include a directional indicator disposed on the first end portion or the second end portion. The direction indicator may include a switch having first position and a second position. In the first position of the switch the direction indicator may provide visual indica of an arrow pointing towards the second side segment and in the second position of the switch of directional indicator may provide visual indica of an arrow pointing towards the first side segment.

In some aspects, the first end portion and the second end portion of the glider bar are positionable in a first location on the first side segment and the second side segment, respectively, such that the first major edge shows a first row of the bead map and in a second location on the first side segment and the second side segment, respectively, such that the first major edge shows a second row of the bead map directly adjacent the first row. The first location and the second location may be offset in a first direction parallel to a lateral side edge relative to one another. The first location and the second location may be offset in a direction perpendicular to the lateral side edge relative to one another.

In certain aspects, the stand includes a leg and an arm. The leg may be pivotally secured to the body adjacent the bottom edge. The leg may have a first pose in which a longitudinal axis of the leg is substantially parallel to the back surface of the body and a second pose in which the longitudinal axis of the leg extends at an angle greater than 5 degrees from the back surface and may be configured to support the front surface at a first support angle from vertical. The arm may be pivotally secured to the back surface and configured to engage the leg to secure the leg in the second pose. The leg may define a first engagement feature and a second engagement feature. The arm may engage with the first engagement feature in the second pose. The leg may have a third pose in which the longitudinal axis of the leg extends at an angle greater than 5 degrees from the back surface and may be configured to support the front surface at a second support angel from vertical different from the first support angle. The arm may engage with the second engagement feature in the third pose which may be different from the second pose.

In another aspect of the present disclosure, a stand includes a body and a glider bar. The body has a front surface, a back surface, a bottom edge, a top edge, and lateral side edges. The back surface is opposite the front surface. The bottom edge, the top edge, and the lateral side edges are disposed at the extremities of the front surface and the back surface and extend between the front surface and the back surface. The bottom edge is opposite the top edge and is configured to support the body on a surface during use. The lateral side edges are opposite one another and extend between top edge and the bottom edge. The body includes two side segments and a central segment. The two side segments extend a length of each lateral side edge between the top edge and the bottom edge. Each side segment extends from the respective lateral side edge towards the opposite lateral side edge. The central segment is disposed between the two side segments. The central segment defines a pocket configured to receive a bead map therein. The central segment includes a substantially transparent cover configured to allow the bead map to be viewed therethrough. The glider bar has a first end portion, a second end portion, and a central portion. The first end portion is selectively secured to a first side segment of the two side segments and the second end portion is selectively secured to a second side segment of the two side segments. The central portion is disposed between the first end portion and the second end portion. The central portion has a first major edge extending between the first end portion and the second end portion and a second major edge extending between the first end portion and the second end portion opposite the first major edge. The first major edge has a first patter is configured to match a single row of a first desired bead stitch. The first major edge is configured to extend across the central segment such that the single row of the first desired bead stitch of the bead map is viewable along the first major edge.

In aspects, the first end portion is magnetically secured to the first side segment. The second end portion may be magnetically secured to the second side segment.

In another aspect of the present embodiment, a method for beading includes placing a bead map within a central segment of a stand such that the bead map is viewable through a cover of the central segment. The method also includes positioning a glider bar of the stand such that a first end portion of the glider bar is secured to a first side segment on a first side of the central segment and a second end portion of the glider bar is secured to a second side segment on a second side of the central segment such that a first major edge of the glider bar extends across the central segment. The first major edge is aligned with the bead map to indicate a first row of beads from the bead map based on a desired stitch pattern. The method also includes stitching the first row of beads as indicated by the first major edge of the glider bar. The method also includes repositioning the glider bar of the stand such that the first end portion of the glider bar along the first side segment and the second end portion of the glider bar along the second side segment such that the first major edge is aligned with the bead map to indicate a second row of bead adjacent to the first row of beads from the bead map based on the desired stitch pattern. The method also includes stitching the second row of beads as indicated by the first major edge of the glider bar.

In aspects, the method includes selecting a first direction on a directional indictor of the stitching direction of the first row of beads before stitching the first row of beads. The direction indicator may be positioned on the first end portion or the second end portion of the glider bar. The method may also include selecting a second direction on the directional indicator indicative of the stitching direction of the second row of beads after stitching the first row of beads and before stitching the second row of beads. The second direction may be opposite the first row of beads. Repositioning the glider includes shifting the glider bar up one row and shifting the glider bar one column to the right or the left.

In some aspects, the method includes adjusting the angle of a body of the stand including rotating a leg of the stand to a desired angle relative to a front surface of the stand and engaging an arm of the stand with the leg to support the stand at the desired angle. Adjusting the angle of the body may include engaging a first engagement feature or a second engagement feature of the leg to select the desired angle. The first engagement feature and the second engagement feature may be spaced apart from one another in a direction extending away from a bottom edge of the body of the stand. The first engagement feature may be associated with a first angle of the body relative to the leg and the second engagement feature may be associated with a second angle for the body relative to the leg.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a front perspective view of a stand provided in accordance with the present disclosure;

FIG. 2 is a front plan view of the front surface of the stand of FIG. 1 with a glider bar of the stand positioned to indicate a first row of a bead map to be stitched;

FIG. 3 is a front plan view of the front surface of the stand of FIG. 1 with the glider bar of the stand positioned to indicate the next, second row of the bead map to be stitched;

FIGS. 4A and 4B are plan views of a major edge of the glider bar for different stitch patterns;

FIG. 5 is side view of the stand of FIG. 1 with an arm of the stand engaged with a first groove of a leg of the stand such that the front surface of the stand is at a first angle relative to a support surface;

FIG. 6 is a back perspective view of the stand of FIG. 5; and

FIG. 7 is a flow chart of a method of beading provided in accordance with the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the term “beader” refers to user of the stand disclosed herein. A beader may be using a bead map to create a beaded object or article. A beaded object may include, but not be limited to, a pendant, an earring, a ring, tubular bead designs, a bracelet, a piece of wall art, a belt, a sleeve, a gauntlet, a guitar strap, or a garment.

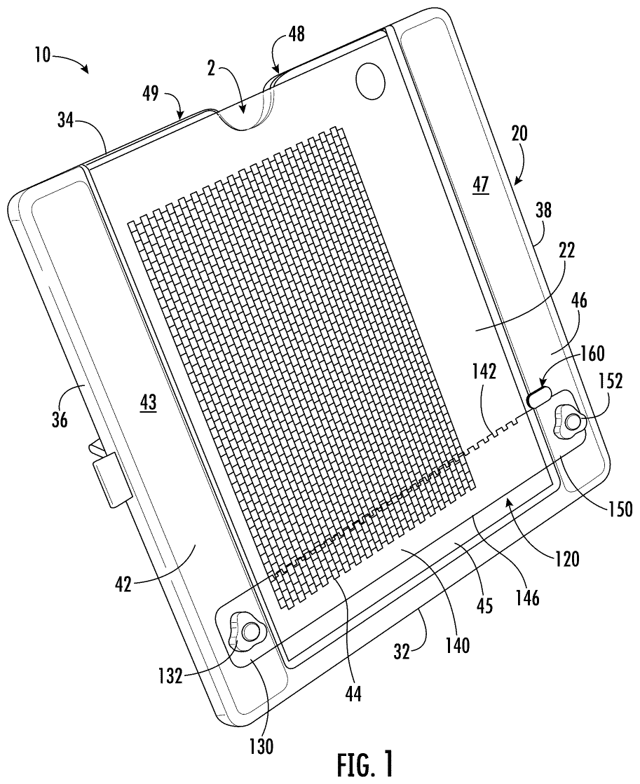

Referring now to FIG. 1, a stand for beading is provided in accordance with the present disclosure and is referred to generally as stand 10. The stand 10 includes a body 20 and a glider bar 120. The body 20 holds a bead map 2 that includes a bead pattern to be stitched. As described in detail below, the glider bar 120 is positioned on the body 20 such that a major edge of the glider bar 120 indicates the current row to be stitched and may indicate a direction of the stitch.

The body 20 has a front surface 22 and a back surface 24 that is opposite the front surface 22. The front surface 22 and the back surface 24 are the major planar surfaces of the body 20. The front surface 22 and the back surface 24 are generally rectangular in shape. The front surface 22 and the back surface 24 extend between a bottom edge 32, a top edge 34, and lateral side edges 36, 38. The lateral side edges 36, 38 may be a first or left side edge 36 and a second or right side edge 38. The front surface 22 may be the forward most surface of the body 20 while the back surface 24 may be recessed relative to the edges 32-38 such that the edges 32-38 may be the rearward most surface of the body 20.

The front surface 22 of the body 20 is divided into a first or left side segment 42, a second or right side segment 46, and a central segment 44 that is disposed between the left side segment 42 and the right side segment 46. Each of the side segments 42, 46 extend from a respective side edge 36, 38 of the body 20 towards the opposite side edge 36, 38. The side segments 42, 46 include a magnetic material 43, 47. The magnetic material 43, 47 is disposed in the respective side segment 36, 38 such that the magnetic material 43, 47 covers substantially the entire surface area of the front surface 22 considered the side segment 36, 38. The magnetic material 43, 47 may be disposed within the body 20 or the magnetic material 43, 47 may form a portion of the front surface 22 of the body 20. In some embodiments, the magnetic material 43, 47 has a color that is visually distinguishable from the rest of the body 20. The side segments 42, 46 may have a width, measured in a distance from one lateral side edge 36 to the other lateral side edge 38, that is equal to one another. In certain embodiments, one side segment 42 may have a width greater or lesser than the other side segment 46.

The central segment 44 is disposed between the side segments 42, 46. The central segment 44 defines a pocket 48 that is accessible through a slit or a slot 49 that opens at the top edge 34. The pocket 48 is sized to hold one or more sheets of paper or other media that includes a bead map 2 thereon. The central segment 44 includes a cover 45 that at the front surface 22. The cover 45 is translucent or transparent such that the bead map 2 disposed within the pocket 48 is visible through the cover 45. The pocket 48 may be sized to hold a standard sheet of letter or A4 paper. In some embodiments, the pocket 48 may be sized to hold other sizes of paper.

The glide bar 120 has a first or left end portion 130 and a second or right end portion 150 with a central portion 140 disposed therebetween. The left end portion 130 is configured to secure to the left side segment 42 and the right end portion 150 is configured to secure to the right side segment 46 such that the central portion 140 extends across the central segment 44 of the body 20. The left end portion 130 and the right end portion 150 may include a magnet disposed therewithin such that the respective end portion 130, 150 is magnetically attracted and secured to the respective magnetic material 43, 47 of the side segments 42, 46. The left end portion 130 and the right end portion 150 may include a handle or a grip 132, 152 that extends outward from a front surface of the glider bar 120. In some embodiments, the left end portion 130 and the right end portion 150 of the glider bar 120 are secured to the respective side segments 42, 46 are secured to one another without the use of the magnets. For example, the left end portion 130 may include a hook that extends around the left edge 36 to secured the left end portion 130 to the left side segment 42. The right end portion 150 may include a magnet or a similar hook to the left end portion 130. In certain embodiments, the side segments 42, 46 may include tracks that receive a portion of the glider bar 120 to secure the glider bar 120 to the body 20.

The glider bar 120 has a first or top major edge 142 and a second or bottom major edge 146 that is opposite the top major edge 142. As will become apparent below, the glider bar 120 can be reversed or rotated such that when the left end portion 130 is secured to the right side segment 46 and the right end portion 150 is secured to the left side segment 42, the bottom major edge 146 is positioned along the top of the glider bar 120 closer to the top edge 34 than the bottom edge 32.

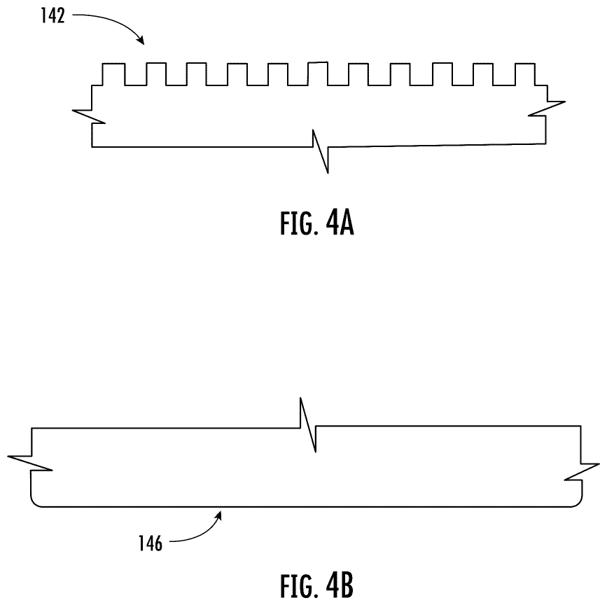

With particular reference to FIG. 4A, the top major edge 142 of the glider bar 120 is patterned to match a single row of a desired bead stitch for the bead map 2 within the pocket 48. Specifically, the top major edge 142 has a pattern to indicate a single row of a peyote stitch of the bead map 2 within the pocket 48. To indicate the single row of a peyote stitch, the top major edge 142 blocks every other bead indicator of the bead map 2. As described below, with the top major edge 142, when a row is completed, the glider bar 120 is shifted up one row and shifted over (to the right or the left) one column to indicate the next row of the peyote stitch of the pattern. In some embodiments, the glider bar 120 may be shifted down a single row instead of up a single row.

With additional reference to FIG. 4B, the bottom major edge 146 may be patterned to match a single row of another desired bead stitch such that a single glider bar 120 may have a first desired bead stitch patterned on top and a second desired bead stitch patterned on the bottom of the glider bar 120. This may allow a glid bar 120 to be flipped over to switch to a different stitch pattern. As shown, the bottom major edge 146 is patterned to match a single row of a brick stitch pattern or other straight and level pattern.

The major edges 142, 146 of the glider bar 120 may be patterned to match a single row of a plurality of different stitch patterns. For example, the major edges 142, 146 of the glider bar 120 may be patterned to match a single row of a brick stitch, a peyote stitch, a square stitch, a loom stitch, a Delica-brick stitch, a Delica peyote stitch, a Delica-square stitch, a Delica-loom stitch, a 2-1 drop peyote stitch, a 2 bead RAW stitch, a 2 bead brick stitch, a 2 drop peyote stitch, 3 bead netting stitch, a 3 bead RAW stitch, a 3 bead brick stitch, a 3 bead peyote stitch, a 5 bead net stitch, a delica-2 drop stitch, a Delica 3 drop stitch, or other desired stitch pattern.

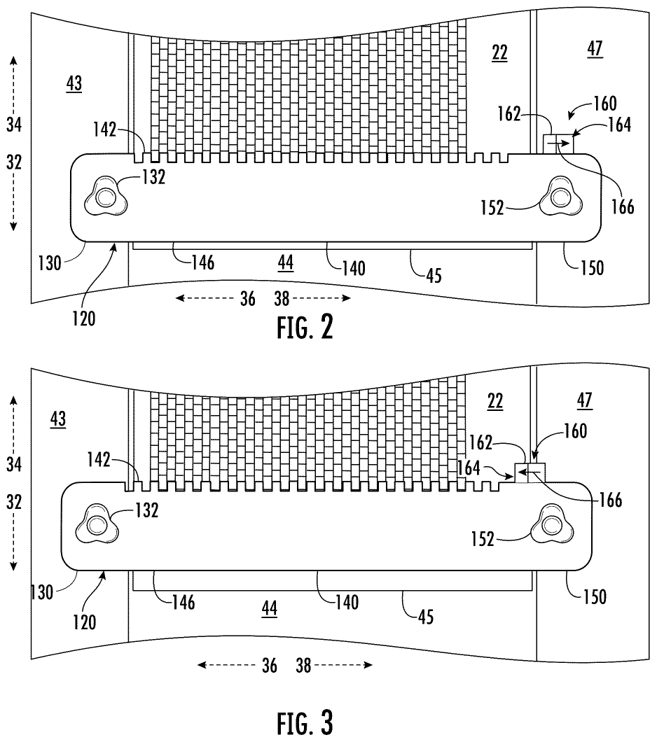

Referring back to FIGS. 2 and 3, the glider bar 120 may include a directional indicator 160. The directional indicator 160 is disposed on one of the left end portion 130 or the right end portion 150 and indicates the current direction of the stitch. The indication of direction may be visual and/or tactile. The directional indicator 160 includes a switch 162 that is moveable between a first position to indicate that the stitch is going from left to right and a second position to indicate that the stitch is going from right to left. The switch 162 may be a slide switch that includes a window 164 with an indicator 166 disposed through the window 164. When the switch 162 is in the first position, the switch 162 covers a portion of the window 164 such that only an arrow pointing from left to right is visible. When the switch 162 is in the second position, the switch 162 covers a portion of the window 164 such that only an arrow pointing from right to left is visible. The switch 162 may include indents or detents such that the switch 162 maintains its position absent an outside force.

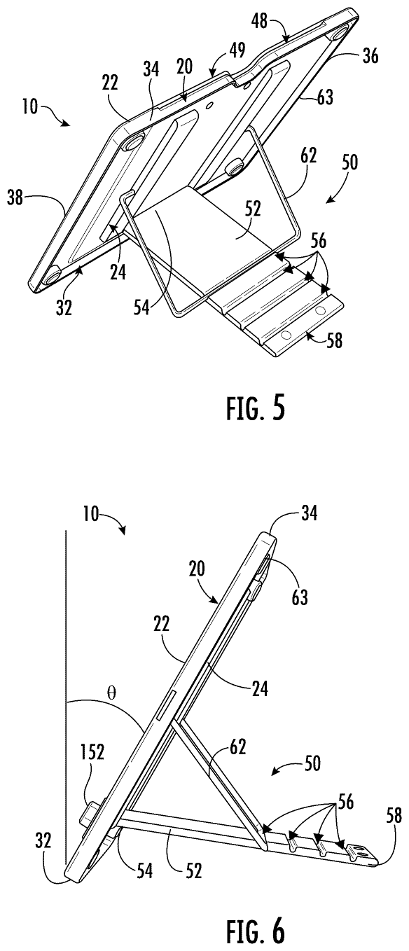

With reference to FIGS. 5 and 6, the stand 10 may include a support structure 50 that includes a leg 52 and an arm 62. The support structure 50 is configured to maintain the front surface 22 of the body 20 at an angle from vertical relative to a support surface. This angle as shown in FIG. 6 is referred to herein as the body angle θ. The leg 52 has a mounted end 54 and a free end 58. The mounted end 54 is rotatably coupled to the body 20 adjacent the bottom edge 32 thereof. The leg 52 has a length such that the leg 52 has a first or stored pose in which a longitudinal axis of the leg 52 is substantially parallel to the front surface 22 and the free end 58 of the leg 52 is between the top edge 34 and the bottom edge 32 of the body 20. In the stored pose, the entire leg 52 may be disposed substantially between the lateral side edges 36, 38 of the body 20 such that the body 20 is substantially flat on the rear side. The leg 52 defines one or more engagement features or engagement grooves 56 that extend in a direction perpendicular to the longitudinal axis of the leg 52. The engagement grooves 56 are spaced apart from one another along the longitudinal axis of the leg 52. As shown, the leg 52 defines five engagement grooves 56.

The arm 62 is rotatably mounted to the back surface 24 of the body 20. The arm 62 has a stored pose in which the arm 62 is disposed along the back surface 24 of the body 20. The arm 62 may be disposed outside the footprint of the leg 52 on the back surface 24 in the stored pose. The back surface 24 may include retainers 63 that extend outward therefrom that selectively engage the arm 62 to retain the arm 62 in the stored pose. In some embodiments, the retainers 63 include magnets on the back surface 24 and on the leg 52 adjacent the free end 58 of the leg 52. The arm 62 has a support pose in which the arm 62 is rotated relative to the back surface 24 such that a portion of the arm 62 is received in one of the engagement grooves 56 of the leg 52 such that the front surface 22 of the body 20 is disposed at s support angle θ relative to vertical. The engagement of the arm 62 with the engagement grooves 56 of the leg 52 may support the front surface 22 at a support angle θ in a range of 15 degrees to 75 degrees, e.g., 15, 30, 45, 60, 75 degrees. The arm 62 may include a lateral section that is received in the engagement grooves 56 to fix the support angle θ of the front surface 22.

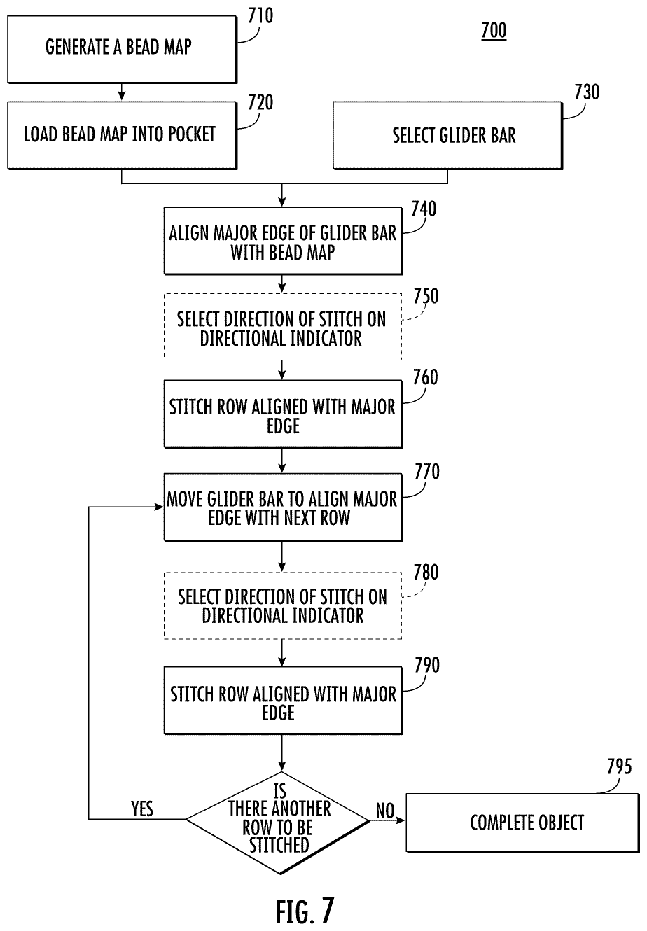

Referring now to FIG. 7, a method of beading is provided in accordance with the present disclosure with reference to the stand 10 of FIGS. 1-6 and is referred to generally as method 700. The method 700 may be used to allow a beader to keep their place in a bead map 2. Allowing a beader to keep their place may improve the efficiency of a beader and/or reduce an amount of time to produce an object. Reducing time or increasing efficiency may reduce the cost of producing objects. The method 700 may include generating a bead map 2 for beading an object to be beaded (Step 710). The bead map 2 may be generated by hand or may be completed using a software package. The bead map 2 may include a color and/or alphanumeric marker to represent particular beads in the bead map 2.

With the bead map 2 created, the bead map 2 is loaded into a pocket 48 the stand 10 (Step 720). The stand 10 may be loaded into the pocket 48 through the slot 49 at the top edge 34. When the bead map 2 is loaded into the pocket 48, a pattern on the bead map 2 is visible through a cover 45 of the front surface 22. The method 700 includes selecting a glider bar 120 having a major edge that includes a pattern for a desired stitch pattern (Step 730). The major edge of the glider bar 120 may be a top major edge 142 or a bottom major edge 146 of the glider bar 120. In some embodiments, a single glider bar 120 may have a top major edge 142 patterned for part of a desired stitch and a bottom major edge 146 patterned for another part of a desired stitch.

With the glider bar 120 selected and the bead map 2 loaded into the pocket 48, the glider bar 120 is secured to the stand 10 with the major edge patterned for the desired stitch aligned with a first row of the bead map 2 to be stitched (Step 740). The major edge may be aligned with any row of the bead map 2 where the beader selects to begin. With the glider bar 120 aligned with he selected row, the method 700 may include selecting a direction of the stitch for the selected row on a directional indicator 160 of the glider bar 120 (Step 750). Selecting the direction may be toggling or moving the switch 62 of the directional indicator 160 to provide visual and/or tactile indication of a direction to move across the major edge of the glider bar 120 to complete the stitch.

When the major edge of the glider bar 120 is aligned with the bead map 2 and the directional indicator 160 is set, the beader may complete the row of the stitch aligned with the major edge of the glider bar 120 by threading a needle or guide through each bead of the pattern indicated on the bead map 2 by the major edge of the glider bar 120 (Step 760). Once the row is completed, the glider bar 120 is moved to align the major edge with the next row (Step 770). The glider bar 120 may be moved based on the stitch pattern. For example, for a peyote stitch pattern, the glider bar 120, with the top major edge 142 orient toward the top edge 34, may be shifted up one row and shifted over to the right or left one column to move the glider bar 120 to align the top major edge 142 with the next row. In contrast, for a brick stitch pattern, the glider bar 120, with the bottom major edge 146 oriented toward the top edge 34, may simply be shifted up one row to move the glider bar 120 to align the bottom major edge 146 with the next row. With the glider bar 120 moved to the next row, the directional indicator 160 is set for the direction of the stitch (Step 780). In some embodiments, the directional indicator 160 is left alone as the direction of the stitch does not change from one row to another. In certain embodiments, the directional indicator 160 is toggled or moved such that the direction is reversed from one row to another, e.g., when using a peyote stitch. With the glider bar 120 aligned with the next row and the directional indicator 160 set, the next row is stitched by threading a needle or guide through each bead of the pattern indicated on the bead map 2 by the major edge of the glider bar 120 (Step 790). If there is another row to be stitched, Steps 770-790 are repeated until all rows are completed. In certain embodiments, the object may require multiple bead maps 2 such that the bead maps 2 may be replaced in the pocket 48 and the glider bar 120 aligned with a first row of the new bead map 2.

Although the method steps are described in a specific order, it should be understood that other steps may be performed in between described steps, described steps may be adjusted so that they occur at slightly different times, or the described steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A stand comprising:
a body including a front surface, a back surface, a bottom edge, a top edge, and lateral side edges, the back surface opposite the front surface, the bottom edge, the top edge, and the lateral side edges disposed at the extremities of the front surface and the back surface and extend between the front surface and the back surface, the bottom edge is opposite the top edge and is configured to support the body on a surface during use, the lateral side edges are opposite one another and extend between the top edge and the bottom edge, the body comprises:
two side segments that extend a length of each lateral side edge between the top edge and the bottom edge, each side segment extends from the respective lateral side edge towards the opposite lateral side edge such that each side segment forms a side area of the front surface, each side segment including a magnetic material substantially covering the respective side area; and
a central segment disposed between the two side segments, the central segment defining a pocket configured to receive a bead map therein, the central segment including substantially transparent cover configured to allow the bead map to be viewed therethrough; and
a glider bar having a first end portion, a second end portion, and a central portion, the first end portion selectively magnetically secured to a first side segment of the two side segments and the second end portion selectively magnetically secured to a second side segment of the two side segments, the central portion disposed between the first end portion and the second end portion, the central portion having a first major edge extending between the first end portion and the second end portion and a second major edge extending between the first end portion and the second end portion opposite the first major edge, the first major edge having a first pattern configured to match a single row of a first desired bead stitch, the first major edge configured to extend across the central segment such that the single row of the first desired bead stitch of the bead map is viewable along the first major edge.

2. The stand according to claim 1, wherein the central segment includes a slot defined along the top edge configured to allow the bead map to be slid into and out of the pocket.

3. The stand according to claim 1, wherein the first pattern is configured to match a loom stitch, a Delica-brick stitch, a Delica-peyote stitch, a peyote stitch, or a brick stitch.

4. The stand according to claim 1, wherein the second major edge has a second pattern configured to match a single row of a second desired bead stitch, the second pattern different from the first pattern, the second major edge configured to extend across the central segment such that a single row of the second desired bead stitch of the bead map is viewable along the second major edge.

5. The stand according to claim 1, wherein the glider bar includes a directional indicator disposed on the first end portion or the second end portion, the directional indicator including a switch having a first position and a second position, in the first position of the switch the directional indicator provides visual indicia of an arrow pointing towards the second side segment and in the second position of the switch of the directional indicator provides visual indicia of an arrow pointing towards the first side segment.

6. The stand according to claim 1, wherein the first end portion and the second end portion of the glider bar are positionable in a first location on the first side segment and the second side segment, respectively, such that the first major edge shows a first row of the bead map and in a second location on the first side segment and the second side segment, respectively, such that that first major edge shows a second row of the bead map directly adjacent the first row.

7. The stand according to claim 6, wherein the first location and the second location are offset in a first direction parallel to a lateral side edge relative to one another.

8. The stand according to claim 7, wherein the first location and the second location are offset in a section direction perpendicular to the lateral side edge relative to one another.

9. The stand according to claim 1, further comprising:
a leg pivotally secured to the body adjacent the bottom edge, the leg having a first pose in which a longitudinal axis of the leg is substantially parallel to the back surface of the body and a second pose in which the longitudinal axis of the leg extends at an angle greater than 5 degrees from the back surface and configured to support the front surface at a first support angle from vertical; and
an arm pivotally secured to the back surface and configured to engage the leg to secure the leg in the second pose.

10. The stand according to claim 9, wherein the leg defines a first engagement feature and a second engagement feature, the arm engaged with the first engagement feature in the second pose, the leg having a third pose in which the longitudinal axis of the leg extends at an angle greater than 5 degrees from the back surface and configured to support the front surface at a second support angle from vertical different from the first support angle, the arm engaged with the second engagement feature in the third pose which is different from the second pose.

11. A stand comprising:
a body including a front surface, a back surface, a bottom edge, a top edge, and lateral side edges, the back surface opposite the front surface, the bottom edge, the top edge, and the lateral side edges disposed at the extremities of the front surface and the back surface and extend between the front surface and the back surface, the bottom edge is opposite the top edge and is configured to support the body on a surface during use, the lateral side edges are opposite one another and extend between the top edge and the bottom edge, the body comprises:
two side segments that extend a length of each lateral side edge between the top edge and the bottom edge, each side segment extends from the respective lateral side edge towards the opposite lateral side edge; and
a central segment disposed between the two side segments, the central segment defining a pocket configured to receive a bead map therein, the central segment including substantially transparent cover configured to allow the bead map to be viewed therethrough; and
a glider bar having a first end portion, a second end portion, and a central portion, the first end portion selectively secured to a first side segment of the two side segments and the second end portion selectively secured to a second side segment of the two side segments, the central portion disposed between the first end portion and the second end portion, the central portion having a first major edge extending between the first end portion and the second end portion and a second major edge extending between the first end portion and the second end portion opposite the first major edge, the first major edge having a first pattern configured to match a single row of a first desired bead stitch, the first major edge configured to extend across the central segment such that the single row of the first desired bead stitch of the bead map is viewable along the first major edge.

12. The stand according to claim 11, wherein the first end portion is magnetically secured to the first side segment.

13. The stand according to claim 12, wherein the second end portion is magnetically secured to the second side segment.

14. A method for beading, the method comprising:
placing a bead map within a central segment of a stand such that the bead map is viewable through a cover of the central segment;
positioning a glider bar of the stand such that a first end portion of the glider bar is secured to a first side segment on a first side of the central segment and a second end portion of the glider bar is secured to a second side segment on a second side of the central segment such that a first major edge of the glider bar extends across the central segment, the first major edge aligned with the bead map to indicate a first row of beads from the bead map based on a desired stitch pattern;
stitching the first row of beads as indicated by the first major edge of the glider bar;
repositioning the glider bar of the stand such that the first end portion of the glider bar along the first side segment and the second end portion of the glider bar along the second side segment such that the first major edge is aligned with the bead map to indicate a second row of beads adjacent the first row of beads from the bead map based on the desired stitch pattern; and
stitching the second row of beads as indicated by the first major edge of the glider bar.

15. The method according to claim 14, further comprising:
selecting a first direction on a directional indicator indicative of the stitching direction of the first row of beads before stitching the first row of beads, the directional indicator positioned on the first end portion or the second end portion of the glider bar; and
selecting a second direction on the directional indicator indicative of the stitching direction of the second row of beads after stitching the first row of beads and before stitching the second row of beads, the second direction being opposite the first row of beads.

16. The method according to claim 14, wherein repositioning the glider bar includes shifting the glider bar up one row and shifting the glider bar one column to the right or the left.

17. The method according to claim 14, further comprising adjusting the angle of a body of the stand including rotating a leg of the stand to a desired angle relative to a front surface of the stand and engaging an arm of the stand with the leg to support the stand at the desired angle.

18. The method according to claim 17, wherein adjusting the angle of the body includes engaging a first engagement feature or a second engagement feature of the leg to select the desired angle, the first engagement feature and the second engagement feature spaced apart from one another in a direction extending away from a bottom edge of the body of the stand, the first engagement feature associated with a first angle of the body relative to the leg and the second engagement feature associated with a second angle for the body relative to the leg.
